(19) United States
(12) Patent Application Publication
(10) Pub. No.: US 2026/0074222 A1
(43) Pub. Date: Mar. 12, 2026

(54) BATTERY ELECTRODE

(71) Applicant: FORD GLOBAL TECHNOLOGIES, LLC, Dearborn, MI (US)

(72) Inventors: Sookyung JEONG, Northville, MI (US); Eun Young GOH, Northville, MI (US); Sangil HAN, Northville, MI (US); Keonseok OH, Novi, MI (US); Michael LERNER, Corvallis, OR (US); Chi PAIK, Grosse Ile, MI (US)

(21) Appl. No.: 18/830,821

(22) Filed: Sep. 11, 2024

(51) Int. Cl. H01M 4/583; H01M 4/02; H01M 4/04; H01M 4/66

(52) U.S. Cl. CPC H01M 4/583; H01M 4/0404; H01M 4/661; H01M 2004/021; H01M 2004/027

(57) ABSTRACT

A battery including a positive electrode assembly and a negative electrode assembly with a porous matrix of graphite-based active material, and lithiophilic nanoparticles occupying pores defined by the porous matrix, is presented. The negative electrode assembly may be formed by loading nickel nanoparticles into graphite, hydrogenating the negative electrode assembly to create porosity within the negative electrode assembly, and galvanizing the negative electrode assembly with silver to replace the nickel nanoparticles.

### TECHNICAL FIELD

This disclosure relates to electrodes for lithium-ion batteries.

### BACKGROUND

In lithium-ion batteries, the low equilibrium potential of a graphite anode results in limited overpotential tolerance. This may make the graphite anode prone to the formation of metallic lithium when the potential drops below a threshold during charging, potentially causing lithium plating under high-current charging conditions and at higher states of charge. Various approaches have been proposed to address the challenges of preventing lithium plating and improving reaction kinetics; however, there remains a lack of scalable methods that may be applied in the production of graphite electrodes for fast-charging lithium-ion batteries.

### SUMMARY

A battery includes a positive electrode assembly and a negative electrode assembly with a porous matrix of graphite-based active material, and lithiophilic nanoparticles occupying pores defined by the porous matrix. The lithiophilic nanoparticles may be silver nanoparticles. The lithiophilic nanoparticles may be configured to form a solid solution with lithium in the negative electrode assembly. The porous matrix of graphite-based active material may have an increased edge surface area compared to non-porous graphite-based active material. The lithiophilic nanoparticles may be in a range of 0.1 to 10 weight percent of the negative electrode assembly. The porous matrix may have a porosity of 10 to 50 percent. The lithiophilic nanoparticles may have an average diameter between 5 to 100 nanometers.

An electrode assembly includes a current collector and a graphite-based active material layer, with electrocatalytic nanoparticles interspersed between particles of the graphite-based active material layer, deposited on the current collector. The graphite-based active material layer may have a porous structure. The electrocatalytic nanoparticles may be silver nanoparticles. The electrocatalytic nanoparticles may be present on surfaces of the graphite-based active material and within pores of the graphite-based active material. The graphite-based active material layer may have a thickness of 50 to 200 micrometers. The electrode assembly may be a negative electrode assembly. The current collector may be a copper foil.

A method of forming an electrode includes loading nickel nanoparticles into a graphite active material to form a nickel-loaded graphite active material, hydrogenating the nickel-loaded graphite active material to form a porous graphite active material, and galvanizing the porous graphite active material with a silver salt solution to replace nickel nanoparticles with silver nanoparticles to form an electrode. The hydrogenating may be performed at a temperature range of 600 to 900 degrees Celsius. The galvanizing may be performed at room temperature. The method may include controlling a radius of the silver nanoparticles by adjusting an amount of silver salt. In other configurations, the method may include depositing the formed electrode on a current collector. The porous graphite active material may have an increased surface area compared to the nickel-loaded graphite active material.

### BRIEF DESCRIPTION OF THE DRAWINGS

FIG. 1 is a schematic diagram of graphite edge activation;

FIG. 2 is a schematic diagram of lithium diffusion in edge-activated graphite;

FIG. 3 is a graph of specific capacity and coulombic efficiency for pure graphite compared to silver-added graphite electrodes;

FIG. 4 is a schematic diagram of an electrode undergoing galvanization;

FIG. 5 is a schematic diagram of a reduction reaction in an electrode; and

FIG. 6 is a flowchart of a method to form an electrode with nitrate additive.

### DETAILED DESCRIPTION

In accordance with this disclosure, detailed embodiments of the electrode structures, manufacturing methods, and battery systems are disclosed herein. These embodiments are representative of the innovative approach to enhancing lithium-ion battery performance through the modification of graphite active material surfaces with lithiophilic and electrocatalytic nanoparticles, specifically silver nanoparticles. The figures and descriptions provided are illustrative and may not represent all possible variations or configurations. Certain features may be exaggerated or minimized to highlight particular aspects of the electrode assemblies and their formation processes. Thus, the specific structural and functional details disclosed are not intended to limit the scope of the invention, but rather to provide a foundational basis for those skilled in the art to implement various embodiments of the claimed subject matter.

Unless explicitly stated otherwise, all numerical values, measurements, percentages, weights, and similar quantitative parameters disclosed herein should be understood as being prefixed by the term “about. ” This convention applies even when the term “about” is not explicitly used. The intent is to encompass variations arising from standard measurement techniques, manufacturing processes, material properties, and the inherent variability in the performance of the electrode structures and battery systems. For instance, when referring to a porosity of “10 to 50 percent,” this range should be interpreted as “about 10 to about 50 percent,” allowing for deviations that do not significantly alter the functionality or performance of the electrode assemblies or the overall battery system.

The present disclosure relates to an approach to increase the performance of lithium-ion batteries, particularly addressing the challenges associated with fast charging and battery longevity. This approach involves the modification of graphite active material surfaces with lithiophilic materials, specifically silver nanoparticles. The approach may involve a two-step process: first, creating a porous structure on the graphite surface, and second, introducing silver nanoparticles onto this modified surface.

The process begins with loading nickel nanoparticles onto the graphite surface. A hydrogenation step is then performed, inducing a porous structure through a reaction of nickel with carbon in graphite and hydrogen gas to produce nickel and methane. This reaction increases the edge plane area, leading to higher rate capability and increased fast-charging characteristics. Following this, the nickel nanoparticles are replaced with silver nanoparticles through a galvanic replacement process in a silver salt solution. This replacement is driven by the difference in reduction potentials where nickel ions gain two electrons to form nickel metal at negative 0.26 volts, while silver ions gain one electron to form silver metal at 0.80 volts. The resulting silver nanoparticles may exist both on the graphite surface and within the pores generated during the hydrogenation step.

The increased edge surface area and porosity facilitate more facile lithium intercalation. Silver nanoparticles may form a solid solution with lithium, inhibiting the lithium-plating process that contributes to lithium loss and dendrite formation. Additionally, silver nanoparticles have higher electronic conductivity than traditional carbon additives, increasing the overall electrochemical reaction kinetics. The combination of porous graphite structure and silver nanoparticles may result in increased fast-charging capabilities compared to unmodified graphite or graphite with silver nanoparticles added without structural modification. The overall processes for creating this modified graphite material may be scalable, making them suitable for industrial application. The two-step approach allows for control over the graphite structure and silver nanoparticle distribution, enabling optimization for specific battery requirements.

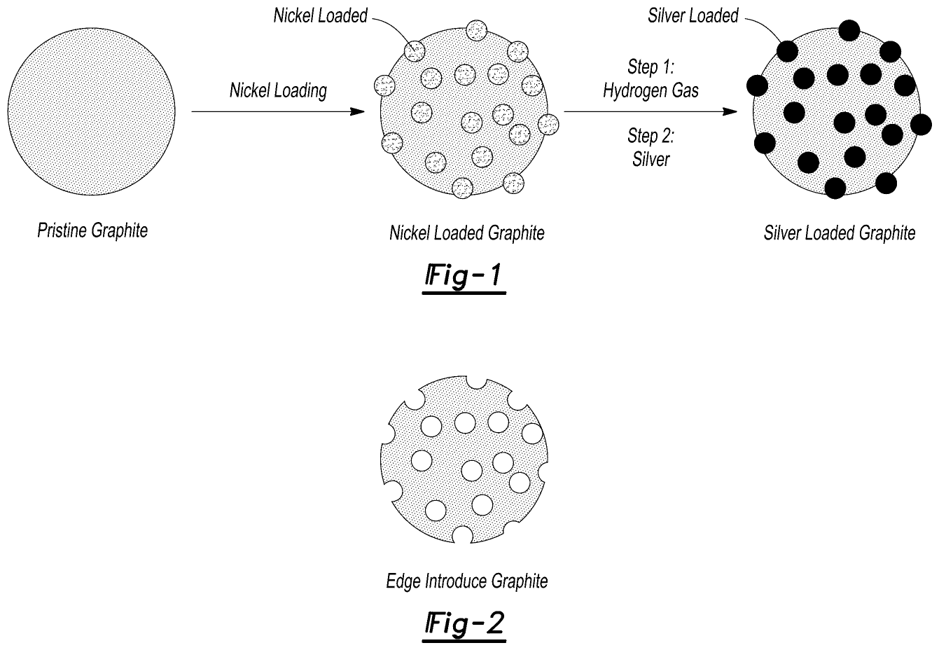

FIG. 1 is a schematic diagram illustrating a two-step process for modifying graphite particles to create electrode materials. The process begins with pristine graphite, depicted as a solid black circle. In the first step, labeled “nickel loading,” nickel particles are loaded onto the graphite surface, resulting in a nickel loaded graphite. The second step involves two sub-steps, step 1 involving the introduction of hydrogen gas and Step 2 addition of silver. This process transforms the nickel loaded graphite into silveer loaded graphite, where silver particles replace the nickel on the graphite surface. This modification process aims to increase the properties of graphite for use as an electrode material, potentially improving its performance in energy storage applications.

FIG. 2 shows the structure of edge-introduced graphite for use in lithium-ion battery electrodes. The image shows a cross-section of a modified graphite particle. The particle maintains its overall circular shape but is characterized by numerous circular voids distributed throughout its graphite structure. These voids represent the introduced edge sites in the graphite. The figure highlights various benefits of this structure which include expansion alleviation and improved lithium ion mass transfer. The introduced edge sites create spaces within the graphite structure that may accommodate volume changes during lithium insertion and extraction, thus alleviating expansion stresses. Additionally, these edge sites improve the mass transfer of lithium ions within the graphite, potentially increasing the electrode's performance in terms of charge and discharge capabilities.

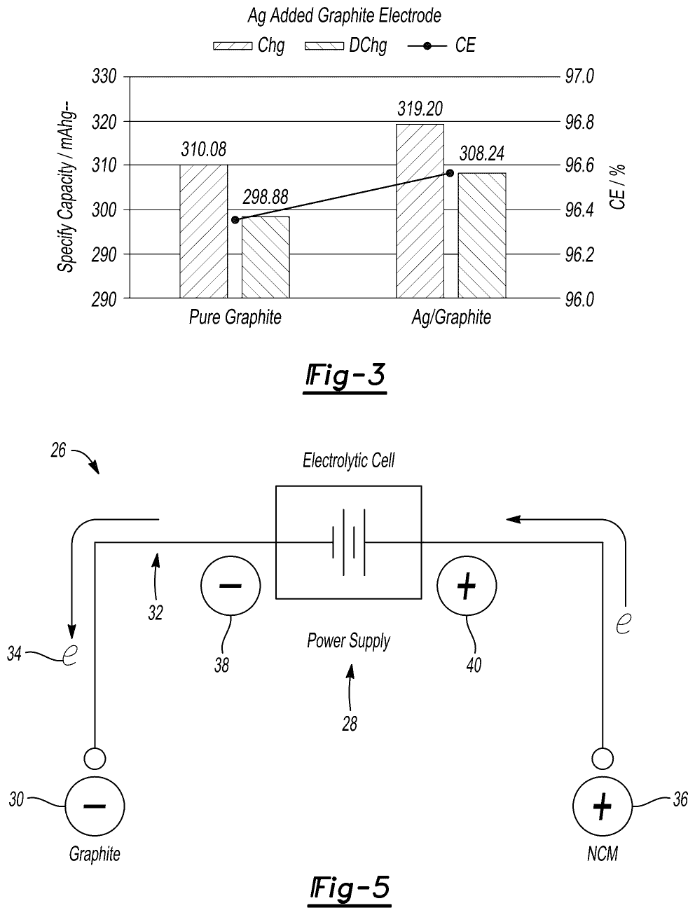

FIG. 3 is a graph of performance comparisons between pure graphite and silver-added graphite electrodes. The graph plots specific capacity (milliamp-hours per gram) and coulombic efficiency (percentage) for both electrode types. For each electrode material, the graph shows three metrics charge capacity (Chg), discharge capacity (DChg), and coulombic efficiency (CE). The pure graphite electrode demonstrates a charge capacity of 310.18 mAh/g and a discharge capacity of 298.88 mAh/g, with a coulombic efficiency of 96.36%. In comparison, the silver-added graphite electrode shows improved performance with a charge capacity of 319.20 mAh/g and a discharge capacity of 308.24 mAh/g, along with a higher coulombic efficiency of 96.57%.

The addition of silver to the graphite electrode results in a noticeable increase in both charge and discharge capacities. The charge capacity improves by approximately 9 mAh/g, while the discharge capacity increases by about 9.4 mAh/g. This suggests that the silver additive increases the electrode's ability to store and release charge. The coulombic efficiency, which is a measure of the electrode's charging efficiency, also shows a slight improvement of 0.21 percentage points with the silver addition. This indicates that the silver-added graphite electrode has a marginally better charge-discharge cycle efficiency compared to the pure graphite electrode.

The performance enhancement observed in the silver-added graphite electrode may be attributed to several factors. The presence of silver may potentially increase the overall conductivity of the electrode, facilitating easier electron transfer during charge and discharge processes. Additionally, silver might create more active sites for charge storage or improve the structural stability of the graphite during cycling. The higher coulombic efficiency suggests that the silver additive may also contribute to reducing irreversible capacity losses during the charge-discharge cycles. As shown by the graph in FIG. 3, the silver-added graphite electrode demonstrates superior performance compared to pure graphite in terms of both capacity and efficiency.

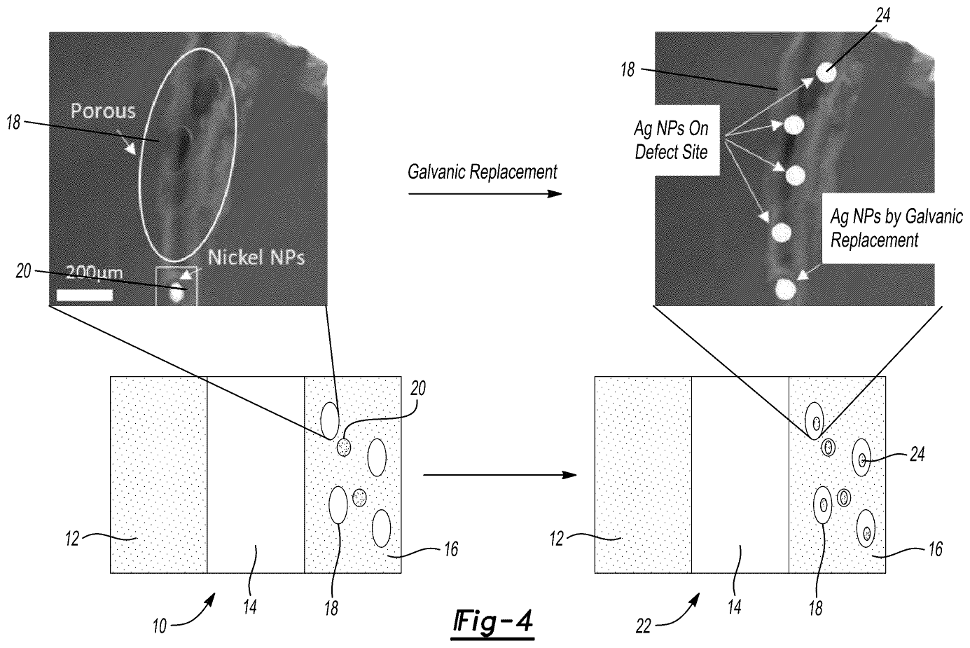

FIG. 4 is a schematic diagram of galvanic replacement in a battery electrode structure. The pre-galvanized electrode 10 has a positive electrode assembly 12 and a negative electrode assembly 16, separated by a separator 14. Within the negative electrode assembly 16, voids 18 and nickel nanoparticles 20 are visible. These voids 18 and nickel nanoparticles 20 are part of the initial structure of the graphite-based active material layer of the negative electrode assembly 16. A microscopic image above the pre-galvanized electrode 10 shows the porous nature of the negative electrode assembly 16, with nickel nanoparticles 20 distributed throughout. The galvanized electrode 22 is shown after the galvanic replacement process. The overall structure of the galvanized electrode 22 remains unchanged, but change occurs within the negative electrode assembly 16. The nickel nanoparticles 20 have been replaced by silver nanoparticles 24 within the voids 18. The microscopic image corresponding to the galvanized electrode 22 shows the presence of the silver nanoparticles 24. The silver nanoparticles 24 are distributed throughout the negative electrode assembly 16.

FIG. 5 is a schematic diagram of an electrolytic cell setup 26 to galvanize graphite electrodes with silver nanoparticles. A power supply 28 provides the electrical energy required to drive the galvanic replacement process. A graphite electrode 30, which serves as the working electrode, is connected by a circuit 32 that facilitates the flow of electrons 34. The electrons 34 flow from the graphite electrode 30 to a counter electrode 36. Negative and positive terminals 38, 40 of the power supply 28 establish the potential difference that drives the electrochemical reaction. In the electrolytic cell setup 26, silver ions from a silver nitrate solution in the electrolyte are reduced at the surface of the graphite electrode 30, forming silver nanoparticles while simultaneously oxidizing and replacing the previously deposited nickel nanoparticles. This galvanic replacement process results in the formation of silver nanoparticles on the surface and within the pores of the graphite electrode 30.

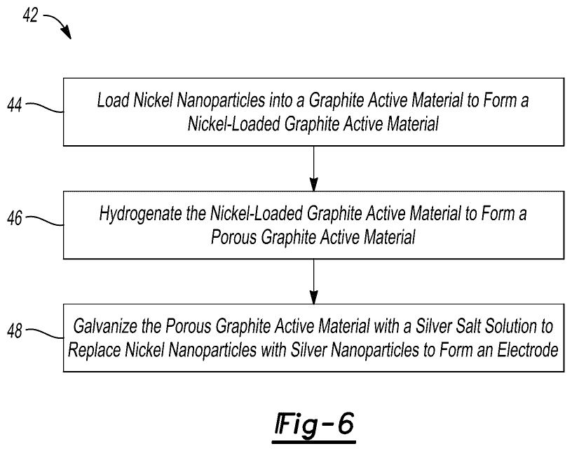

FIG. 6 is a flowchart of a process for forming an electrode 42. The first step 44 involves loading nickel nanoparticles into a graphite active material to form a nickel-loaded graphite active material. This initial step prepares the graphite substrate with nickel nanoparticles, which will serve as precursors for the subsequent modifications. The second step 46 involves hydrogenating the nickel-loaded graphite active material to form a porous graphite active material. This hydrogenation process may involve exposing the nickel-loaded graphite to hydrogen gas under specific conditions, resulting in the creation of a porous structure within the graphite. This increases the surface area and creates additional sites for the final modification. The third step 48 includes galvanizing the porous graphite active material with a silver salt solution to replace nickel nanoparticles with silver nanoparticles, thereby forming the electrode. This galvanic replacement process replaces the nickel nanoparticles with silver nanoparticles.

While the specific embodiments of the electrode structures, methods of forming such structures, and the resulting battery systems have been described in detail, these embodiments are not exhaustive of all potential configurations. The language used in this specification is intended for descriptive purposes and not as a limitation of the invention's scope. Modifications and variations may occur without departing from the core inventive concepts described herein. Additionally, the features and elements of various embodiments disclosed may be combined in novel ways to form additional embodiments within the scope of the claimed subject matter, even if such combinations are not explicitly detailed in this specification.

What is claimed is:

1. A battery comprising:
a positive electrode assembly; and
a negative electrode assembly with a porous matrix of graphite-based active material, and lithiophilic nanoparticles occupying pores defined by the porous matrix.

2. The battery of claim 1 wherein the lithiophilic nanoparticles are silver nanoparticles.

3. The battery of claim 1 wherein the lithiophilic nanoparticles are configured to form a solid solution with lithium in the negative electrode assembly.

4. The battery of claim 1 wherein the porous matrix of graphite-based active material has an increased edge surface area compared to non-porous graphite-based active material.

5. The battery of claim 1 wherein the lithiophilic nanoparticles are in a range of 0.1 to 10 weight percent of the negative electrode assembly.

6. The battery of claim 1 wherein the porous matrix has a porosity of 10 to 50 percent.

7. The battery of claim 1 wherein the lithiophilic nanoparticles have an average diameter between 5 to 100 nanometers.

8. An electrode assembly comprising:
a current collector; and
a graphite-based active material layer, with electrocatalytic nanoparticles interspersed between particles of the graphite-based active material layer, deposited on the current collector.

9. The electrode assembly of claim 8 wherein the graphite-based active material layer has a porous structure.

10. The electrode assembly of claim 8 wherein the electrocatalytic nanoparticles are silver nanoparticles.

11. The electrode assembly of claim 8 wherein the electrocatalytic nanoparticles are present both on surfaces of the graphite-based active material layer and within pores of the graphite-based active material layer.

12. The electrode assembly of claim 8 wherein the graphite-based active material layer has a thickness of 50 to 200 micrometers.

13. The electrode assembly of claim 8 wherein the electrode assembly is a negative electrode assembly.

14. The electrode assembly of claim 8 wherein the current collector is a copper foil.

15. A method of forming an electrode comprising:
loading nickel nanoparticles into a graphite active material to form a nickel-loaded graphite active material;
hydrogenating the nickel-loaded graphite active material to form a porous graphite active material; and
galvanizing the porous graphite active material with a silver salt solution to replace nickel nanoparticles with silver nanoparticles to form the electrode.

16. The method of claim 15 wherein the hydrogenating is performed at a temperature range of 600 to 900 degrees Celsius.

17. The method of claim 15 wherein the galvanizing is performed at room temperature.

18. The method of claim 15, further comprising controlling a radius of the silver nanoparticles by adjusting an amount of silver salt.

19. The method of claim 15, further comprising depositing the formed electrode on a current collector.

20. The method of claim 15 wherein the porous graphite active material has an increased surface area compared to the nickel-loaded graphite active material.
